(19) United States
(12) Patent Application Publication
(10) Pub. No.: US 2015/0321036 A1
(43) Pub. Date: Nov. 12, 2015

(54) THERMAL EXPANSION ASSEMBLY FOR WATER MIST FIRE SUPPRESSION SYSTEM

(71) Applicants: Antti Tapio Hurme, Helsinki (FI); Olli Heikklla, Vantaa (FI); Tero Kujamaki, Rajamaki (FI); Arto Huotari, Helsinki (FI); Lauri Manninen, Hyvinkaa (FI)

(72) Inventors: Antti Tapio Hurme, Helsinki (FI); Olli Heikklla, Vantaa (FI); Tero Kujamaki, Rajamaki (FI); Arto Huotari, Helsinki (FI); Lauri Manninen, Hyvinkaa (FI)

(21) Appl. No.: 14/410,435

(22) PCT Filed: Jun. 28, 2012
(86) PCT No.: PCT/FI2012/050677

§ 371 Date: Dec. 22, 2014

(51) Int. Cl. A62C 35/68; A62C 35/60

(52) U.S. Cl. CPC A62C 35/68; A62C 35/60

(57) ABSTRACT

An apparatus and method are provided for maintaining a standby pressure in a fire suppression system. The fire suppression system includes at least on spray head and a drive source coupled to the at least one spray head by a supply line. The supply lines delivers extinguishing medium to the spray head. The drive source maintains a standby pressure of the extinguishing medium in the supply line when the system is inactive. A release line is coupled at a first end to the supply line. The release line includes a thermal expansion assembly. When the system is inactive and the standby pressure exceeds a first threshold, the thermal expansion assembly releases extinguishing medium from the system to reduce the standby pressure. When the system is active and the standby pressure exceeds the first threshold, the thermal expansion assembly does not release extinguishing medium from the system.

### BACKGROUND OF THE INVENTION

The invention relates generally to fire suppression systems and, more particularly, to the thermal expansion of a fluid in the fire suppression system.

Conventional fire suppression systems typically involve sprinklers positioned strategically within an area where fire protection is desired, such as inside a building. The sprinklers remain inactive most of the time. Even though the sprinklers are inactive, many systems include fire suppression fluid within the conduits that supply the sprinklers. The fluid is pressurized and it is necessary to maintain an adequate seal to prevent any leaks at the sprinklers or system joints while they are inactive.

In climates where extreme temperatures are reached, fire suppression systems can generally be designed so that the fluid within the pipes of the system does not freeze. If the fluid does freeze, the pipes of the fire suppression system containing the fluid can be damaged or the system may be rendered inoperable. In addition, environments that cause the fluid to boil or climates susceptible to extreme temperature fluctuations may adversely affect the pipes and other components of the fire suppression system due to thermal expansion of the fluid. Mechanics periodically check the standby pressure and release excess fluid if necessary to prevent damage to current fire suppression systems. These manual checks are inefficient and time consuming.

### BRIEF DESCRIPTION OF THE INVENTION

According to one embodiment of the invention, a fire suppression system includes at least on spray head and a drive source coupled to the at least one spray head by a supply line. The supply lines delivers extinguishing medium to the spray head. The drive source maintains a standby pressure of the extinguishing medium in the supply line when the system is inactive. A release line is coupled at a first end to the supply line. The release line includes a thermal expansion assembly. When the system is inactive and the standby pressure exceeds a first threshold, the thermal expansion assembly releases extinguishing medium from the system to reduce the standby pressure. When the system is active and the standby pressure exceeds the first threshold, the thermal expansion assembly does not release extinguishing medium from the system.

According to another embodiment of the invention, an antifreeze expansion assembly for use in a fire suppression system is provided including a tubular conduit including a first open end and a second closed end. A spring member is connected to the second end. The first end is coupled to a first portion of a supply line of the fire suppression system and a second portion of the supply line is connected to the conduit at a distance from the second end. A piston is disposed within the conduit and is slidable between a first position and a second position. When the piston is in the second position, the spring member is compressed and the piston does not obstruct a flow path from the first portion of the supply to line to the second portion of the supply line.

According to yet another embodiment of the invention, a method is provided for maintaining a standby pressure in a fire suppression system having a driving source coupled to a spray head by a supply line for delivering extinguishing medium thereto. The method includes monitoring a standby pressure in the fire suppression system. A thermal expansion assembly coupled to the supply line opens when the standby pressure exceeds a threshold and the driving source is inoperable. Opening of the thermal expansion assembly releases extinguishing medium and pressure from the system. The thermal expansion assembly is closed once the standby pressure is less than or equal to the threshold.

According to another embodiment of the invention, a method of maintaining a standby pressure of a fire suppression system containing both antifreeze and extinguishing medium within a predetermined threshold including expanding either the antifreeze of the extinguishing medium in the system as a result of a temperature change. A portion of an antifreeze-extinguishing medium interface moves to accommodate the expansion. A thermal expansion assembly opens to release extinguishing medium from the system.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of an exemplary fire suppression system;

FIG. 2 is a schematic diagram of another exemplary fire suppression system;

FIG. 3 is a schematic diagram of a fire suppression system having a thermal expansion assembly according to an embodiment of the invention;

FIG. 4 is a cross-section of a thermal expansion assembly for use in a fire suppression system according to an embodiment of the invention;

FIG. 5 is a schematic diagram of a fire suppression system having an alternate thermal expansion assembly according to an embodiment of the invention; and

FIG. 6 is a schematic diagram of a fire suppression system having an antifreeze expansion assembly according to an embodiment of the invention; and

FIG. 7 is a schematic diagram of a fire suppression system including an alternate antifreeze expansion assembly according to an embodiment of the invention.

### DETAILED DESCRIPTION OF THE INVENTION

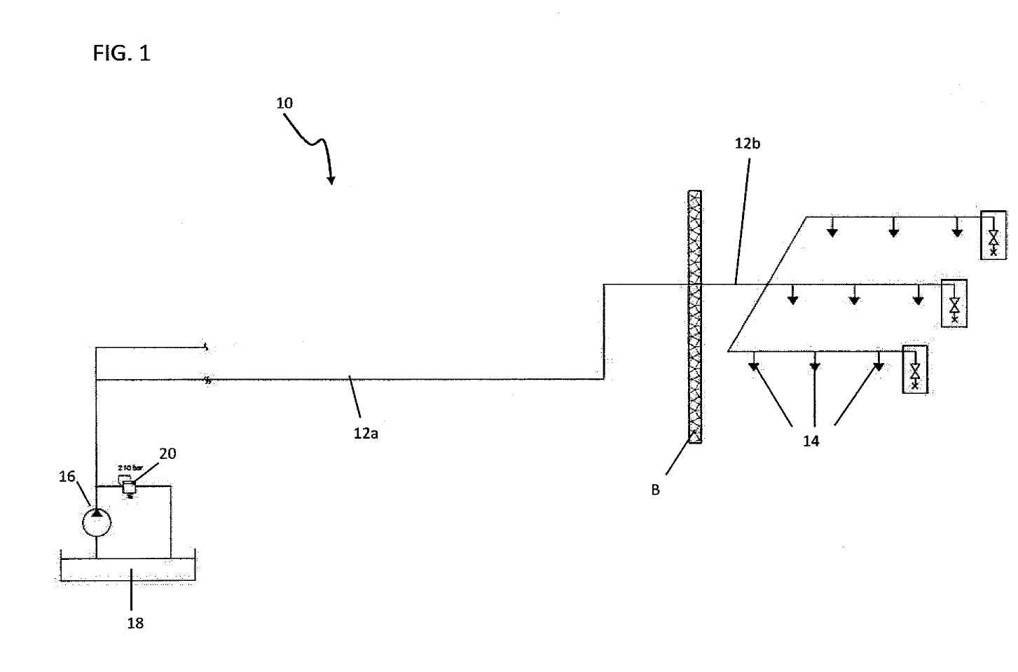

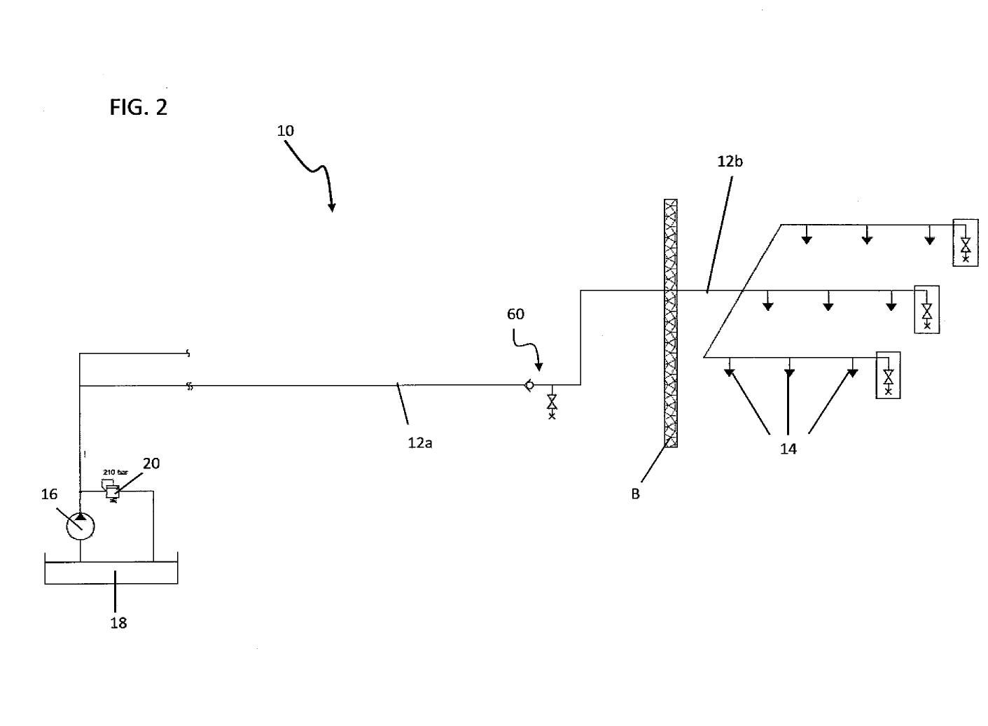

Referring now to FIG. 1, a known fire suppression system 10 including a drive source 16 is illustrated. A supply line 12 extends from the drive source 16 to a plurality of spray heads 14 to supply an extinguishing medium thereto. In one embodiment, the spray heads 14 include nozzles with small openings arranged to spray an aqueous liquid mist. The drive unit 16 is also connected to an extinguishing medium source 18, such as a pipeline network or a tank. The spray heads 14 of each fire suppression system 10 may be positioned in the same general area as the drive source 16, or alternatively, may be, separated from the drive source 16 by a barrier B, such as a wall for example. Depending on the location of the spray heads 14 and the type of fire suppression system 10, any portion of the system, the spray heads 14 in particular, may be susceptible to extreme temperatures, such as −40° C. or 60° C. for example, or extreme temperature fluctuations (see FIGS. 1 and 2).

The drive source 16, which includes a fire pump and a low flow pneumatic pump in one embodiment, maintains a constant pressure in the supply line 12, also referred to as a standby pressure, when the fire suppression system 10 is not active. The drive source 16 applies a constant pneumatic pressure at the inlet of the supply line 12, however, the drive source 16 only generates a flow if the pressure in the system is below a minimum level. A pressure relief valve 20 is coupled to the supply line 12 and has a threshold, for example 210 bar, such that if the standby pressure of the system 10 exceeds the threshold, the pressure will cause the relief valve 20 to open and remain open until the standby pressure falls below the threshold to an acceptable level.

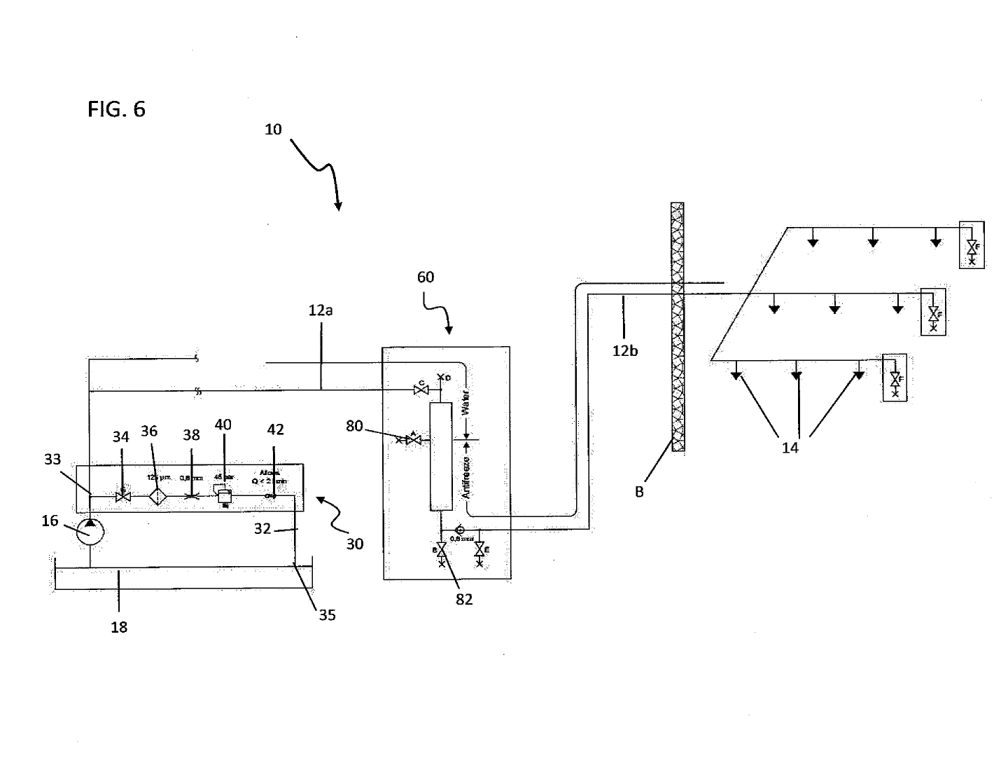

An alternate known fire suppression system 10 is illustrated in FIG. 2. In one embodiment, the portion 12b of the supply line 12 adjacent the spray heads 14 is filled with antifreeze and the portion 12a of the supply line adjacent the drive source 16 is filled with an extinguishing medium, such as water for example. Portions 12a and 12b of the supply line 12 connect at an antifreeze-extinguishing medium interface 60, such as a check valve for example, positioned near the bather B to prevent mixing of the extinguishing medium and antifreeze within the system 10. In some fire suppression systems 10, the antifreeze-extinguishing medium interface 60 is positioned at a vertical section of the supply line 12 (see FIG. 6). By orienting the antifreeze-extinguishing medium interface 60 vertically, so that gravity, in conjunction with the different densities of the extinguishing medium and the antifreeze, prevents mixing of the two fluids.

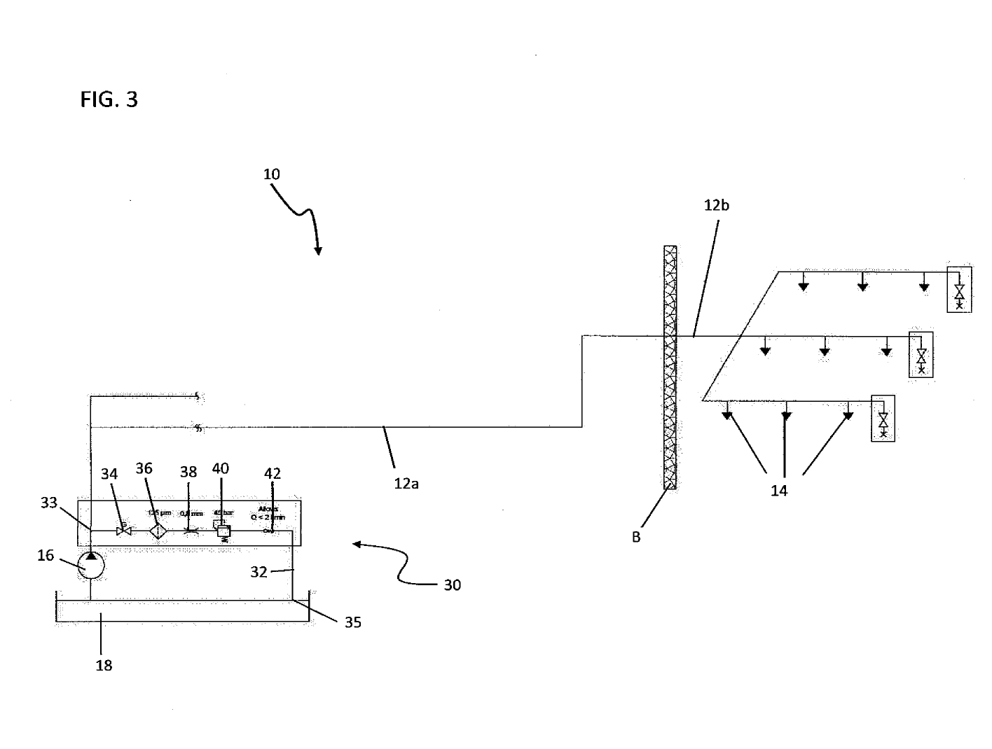

The extinguishing medium and/or the antifreeze within the supply line 12 may experience volume changes due to thermal expansion when the ambient temperature fluctuates significantly, for example between night and day or between seasons. Such volume changes may cause an increase in the standby pressure of the supply line 12, and ultimately affect the functionality of the system 10. Referring now to FIG. 3, a fire suppression system 10 additionally includes a thermal expansion assembly 30 to release additional standby pressure in the system 10 caused by thermal expansion of the fluid in the supply line 12. The thermal expansion assembly 30 may be included in systems 10 that use only extinguishing medium (see FIG. 1) or in systems 10 that use both extinguishing medium and antifreeze (see FIG. 2). A first end 33 of the release line 32 connects the thermal expansion assembly 30 to the supply line 12. In one embodiment, the second end 35 of release line 32 is connected to a sewer to release some of the extinguishing medium from the supply line 12. In another embodiment, the second end 35 of the release line 32 is connected to the extinguishing medium source 18 to recycle the extinguishing medium released from the supply line 12 within the system 10.

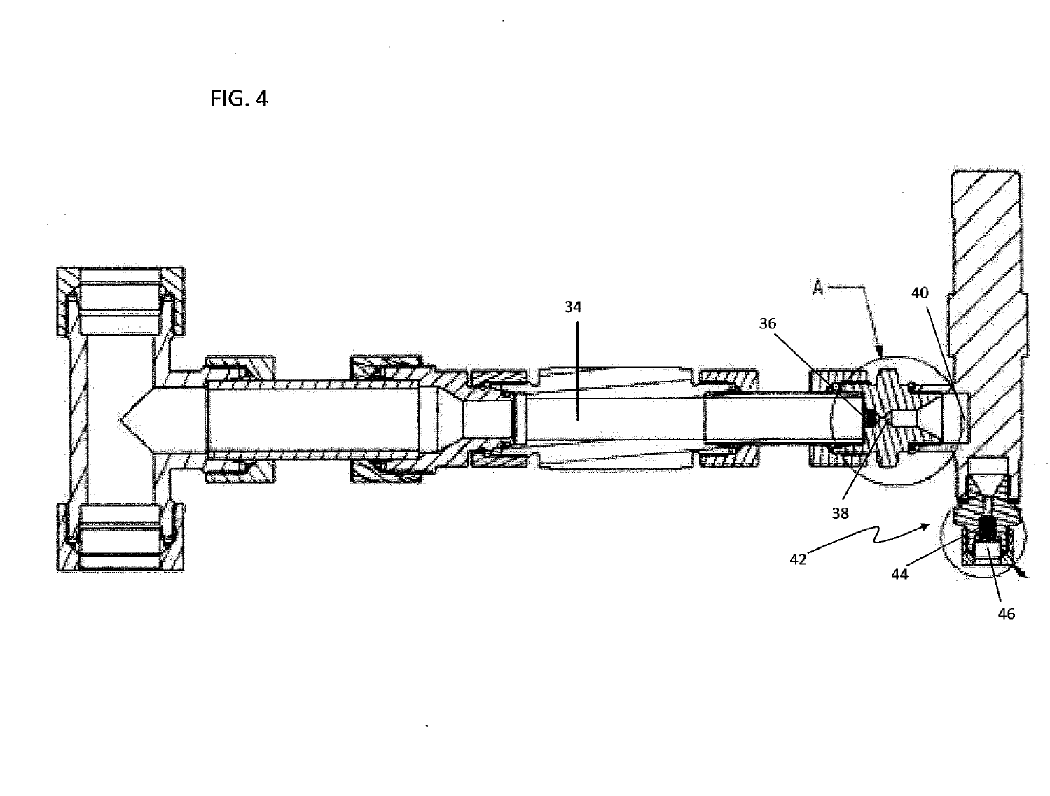

The thermal expansion assembly 30, shown in greater detail in FIG. 4, includes a shutoff valve 34, a filter 36, and a throttle 38. The shutoff valve 34 may be provided for maintenance purposes to prevent flow into the release line 32 when the valve 34 is closed. However, the shutoff valve 34 generally remains open during normal operation of the system 10 such that the extinguishing medium in the portion 12a of the supply line 12 will flow freely into the release pipe 32. After passing through the open shutoff valve 34, the extinguishing medium flows through filter 36 and the adjacent throttle 38. The filter 36 prevents contaminants in the supply line 12 and the extinguishing medium from interfering with the operation of the thermal expansion assembly 30 and the throttle 38 controls the flow rate of the extinguishing medium in the release line 32.

In one embodiment, the thermal expansion assembly 30 includes a pressure relief valve 40 disposed along the release line 32 between the throttle 38 and the second end 35. The relief valve 40 has a predetermined threshold, for example 45 bar, such that if the standby pressure of the system 10 exceeds the predetermined threshold, the pressure will cause the relief valve 40 to open and remain open until the standby pressure falls below the predetermined threshold. The predetermined threshold of the relief valve is less than the pressure required to activate an alarm (not shown) in the fire suppression system 10. When the driving source 16 operates, such as when the fire suppression system 10 is active, the pressure in the system is greater than the predetermined threshold of the pressure relief valve 40. Therefore the pressure relief valve 40 will remain open as long as the driving source 16 is active.

Further along the flow path of the release line 32 is a bleed valve 42 including a piston 44 connected to a biasing member 46, such as a spring for example. The biasing member 46 biases the piston 44 into an open position, to allow the extinguishing medium to flow through the bleed valve 42. If the flow rate of the extinguishing medium is above a predetermined threshold, such as 2 L/min for example, the flow of the extinguishing medium will cause the piston 44 to compress the biasing member 46, thereby blocking the flow path within the release line 32. In one embodiment, the predetermined threshold of the bleed valve 42 is less than the flow rate of the extinguishing medium being actively pumped into the supply line 12 by the driving source 16. Closing the bleed valve 42 while the driving source 16 is active ensures that the extinguishing medium being pumped into the supply line 12 will reach the spray heads 14 with a desired pressure.

The thermal expansion assembly 30 maintains the standby pressure in the fire suppression system 10 within an allowable threshold. When the system 10 is inactive, the drive source 16 applies a constant pressure to the extinguishing medium in the supply line 12. If a change in temperature causes the extinguishing medium to expand, the increase in pressure will open the pressure relief valve 40, thereby allowing the expanding medium to flow into the bleed valve 42. If the flow rate of the extinguishing medium is less than the threshold of the bleed valve 42, the bleed valve 42 will remain in an open position, such that the extinguishing medium will flow through the bleed valve 42 and out a second end 35 of the release line 32. Once enough extinguishing medium has been released from the supply line 12 of the system 10, the standby pressure will return to the allowable threshold, and the pressure relief valve 40 will bias closed.

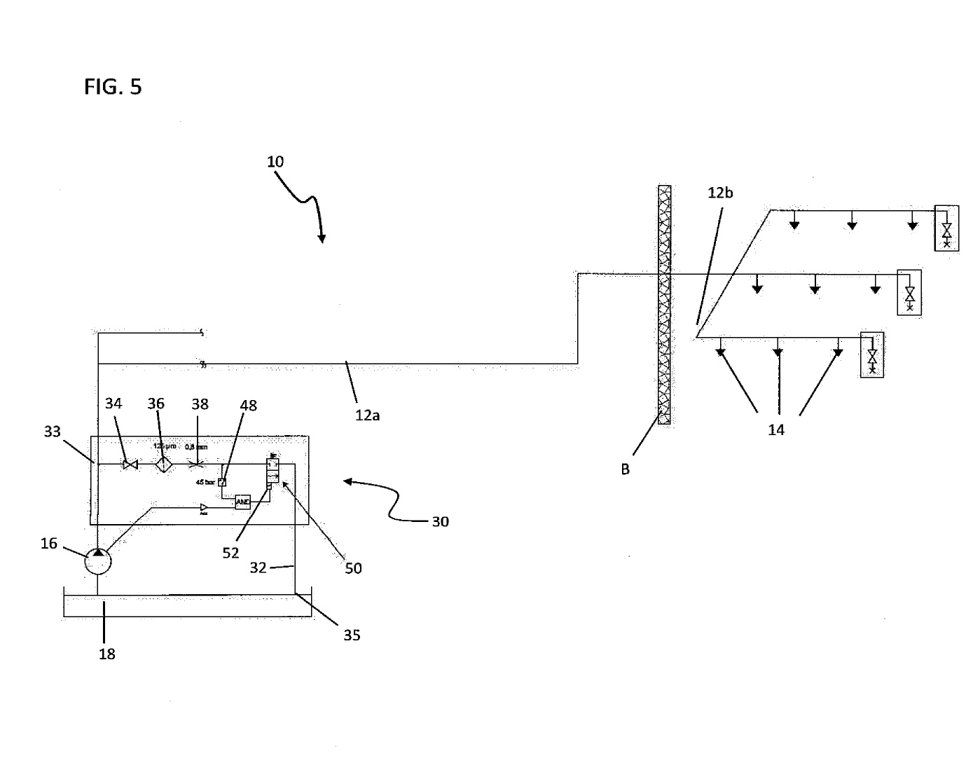

In another embodiment, illustrated in FIG. 5, the thermal expansion assembly 30 is electric and includes a pressure switch 48 and a valve 50, for example a directional control valve, in place of the pressure relief valve 40 and the bleed valve 42. The pressure relief switch 48 is coupled to the driving source 16 and to a solenoid 52 that moves the valve 50 between an open position and a closed position. When the pressure switch 48 detects that the pressure in the system 10 is greater than a predetermined threshold, such as 45 bar for example, and the drive source 16 is not operating, the pressure switch 48 will send a signal to the solenoid 52 to open the valve 50. However, if the drive source 16 is active, the solenoid 52 will not open the valve 50, because the pressure in the system 10 moves the extinguishing medium and antifreeze through the supply line 12 to the spray heads 14.

The pressure switch 48 continuously monitors the standby pressure in the system 10. If a change in temperature causes the extinguishing medium to expand within the supply line 12, the pressure switch 48 detects the increase in pressure. The pressure switch 48 will then detects the status of the driving source 16. After determining that the driving source 16 is inactive, the pressure switch 48 will generate and send a signal to the solenoid 52. In response to the signal, the solenoid 52 opens the valve 50, allowing extinguishing medium to flow therethrough. Once enough extinguishing medium has been released from the system 10, the pressure switch 48 will detect when the standby pressure of the system 10 is again within the allowable threshold. The pressure switch 48 then sends a signal to the solenoid 52 to close the valve 50.

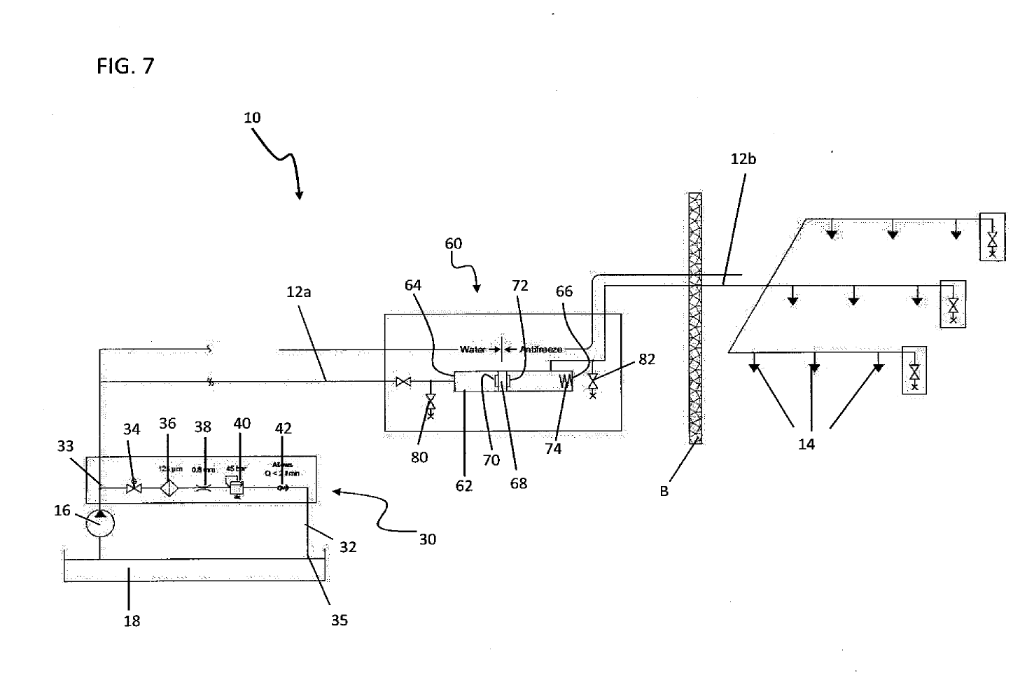

Referring now to FIGS. 6 and 7, an antifreeze-extinguishing medium interface 60 may cooperate with the thermal expansion assembly 30 of either of the systems 10 shown in FIGS. 3 and 5, to accommodate the thermal expansion that creates an increased standby pressure within the supply line 12. A known vertically oriented antifreeze-extinguishing medium interface 60, illustrated in FIG. 6, includes a filling valve 80 near a first end and a sampling valve 82 near a second, opposite end. When the temperature of the antifreeze increases, the antifreeze expands, causing extinguishing medium to be released through the thermal expansion assembly 30. If the temperature decreases causing the antifreeze in the antifreeze-extinguishing medium interface 60 to contract, the drive source 16 adds additional extinguishing medium to the supply line 12 to maintain the standby pressure at an acceptable threshold.

Another antifreeze-extinguishing medium interface 60, shown in FIG. 7, includes a generally horizontal tubular conduit 62 and a piston 68 disposed within the interior of the conduit 62. A first end 64 of the conduit 62 is connected to portion 12a of the supply line 12. Portion 12b of the supply line 12 is connected to the conduit 62 a distance from the second end 66. In one embodiment, the distance is at least equal to the length of the piston 62. The extinguishing medium contacts a first surface 70 of the piston 68 and the antifreeze contacts a second, opposite surface 72 of the piston 68. The piston 68 has a diameter complementary to the inner diameter of the conduit 62, allowing the piston 68 to slide within the conduit, while providing a seal that separates the extinguishing medium and the antifreeze. A biasing member 74 is connected to the closed second end 66 of the conduit 62.

If the ambient temperature causes thermal expansion of either the antifreeze or the extinguishing medium, the piston 68 will slide within the conduit 62 to adapt to the new pressure, and extinguishing medium may be added to or released from the system 10 as necessary. When a spray head 14 activates the fire suppression system 10, the driving source 16 pumps the extinguishing medium through portion 12a of the supply line 12 with a pressure sufficient to move the piston 68 relative to the conduit 62. As the piston 68 slides, the piston 68 applies a pressure to the antifreeze, thereby forcing it through portion 12b of the supply line 12 to the spray heads 14. After all of the antifreeze has been forced out of the conduit 62, the piston 68 contacts and depresses the biasing member 74, such that the piston 68 is positioned between the second end 66 and the connection to portion 12b of the supply line 12. Moving the piston 68 to a position adjacent the second end 66 removes the piston 68 from the flow path, thereby allowing the extinguishing medium to flow into portion 12b of the supply line 12 and to the spray heads 14. After the driving source 16 is shut off or deactivated, the biasing member 74 will bias the piston 68 back into an inactive position towards the center of the conduit 62.

By including a thermal expansion assembly 30 in the fire suppression system 10, manual checks of the standby pressure in the system 10 are no longer required. The system 10 can automatically release additional pressure from the system by removing some of the fluid from the supply line 12. Systems 10 including a thermal expansion assembly 30 will have improved accuracy and life because the increased pressure will reduce the occurrence of false alarms and leaks. In addition, the antifreeze expansion assembly 60 that may be used in conjunction with the thermal expansion assembly 30 does not rely on gravity to separate the extinguish medium and antifreeze. Consequently, the antifreeze in the system 10 does not dilute over time, regardless of how many volume changes occur in the system 10.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fire suppression system comprising:
at least one spray head;
a drive source coupled to the at least one spray head by a supply line that delivers an extinguishing medium thereto, wherein the drive source maintains the extinguishing medium in the supply line at a standby pressure when the system is inactive;
a release line, coupled at a first end to the supply line, the release line including a thermal expansion assembly such that when the system is inactive and the standby pressure exceeds a first threshold, the thermal expansion assembly releases extinguishing medium to reduce the standby pressure, and when the system is active and the standby pressure exceeds the first threshold, the thermal expansion assembly does not release extinguishing medium.

2. The fire suppression system according to claim 1, where the first threshold is less than a pressure required to activate an alarm in the system.

3. The fire suppression system according to claim 2, where the first threshold is a pressure of about 45 bar.

4. The fire suppression system according to claim 1, wherein a second end of the release line is connected to a sewer.

5. The fire suppression system according to claim 1, wherein a second end of the release line is connected to an extinguishing medium source for reuse within the fire suppression system.

6. The fire suppression system according to claim 1, wherein the thermal expansion assembly includes:
a pressure relief valve operable between an open position and a closed position, such that when the standby pressure in the thermal expansion assembly exceeds the first threshold, the pressure relief valve is opened; and
a bleed valve operable between an open position and a closed position and having a second threshold, such that when a flow rate in the thermal expansion assembly exceeds the second threshold, the bleed valve closes.

7. The fire suppression system according to claim 6, wherein the bleed valve includes a piston coupled to a biasing member.

8. The fire suppression system according to claim 6, wherein when the bleed valve is closed, the piston compresses the biasing member, blocking a flowpath of the extinguishing medium through the thermal expansion assembly.

9. The fire suppression system according to claim 6, wherein the second threshold of the thermal expansion assembly is less than the flow rate of the drive source when active.

10. The fire suppression system according to claim 9, wherein the second threshold of the thermal expansion assembly is a flow rate of about 2 L/min.

11. The fire suppression system according to claim 1, further including an antifreeze-extinguishing medium interface in the supply line.

12. The fire suppression system according to claim 1, wherein the thermal expansion assembly includes:
a valve;
a solenoid operably coupled to the valve configured to move the valve between an open position and a closed position; and
a pressure switch configured to measure a pressure in the thermal expansion assembly, the pressure switch being in communication with the solenoid and the driving source, such that when the pressure exceeds the first threshold and the driving source is inactive, the pressure switch sends a signal to the solenoid to open the valve.

13. An antifreeze-extinguishing medium interface for use in a fire suppression system having a driving source coupled to at least one spray head by a supply line for delivering extinguishing medium thereto, comprising:
a conduit including a first open end and a second closed end having a biasing member connected thereto, wherein the first end is coupled to a first portion of the supply line and a second portion of the supply line is coupled to an opening in the conduit at a distance from the second end;
a piston disposed within the conduit, slidable between a first position and a second position, wherein when the piston is in the second position, the biasing member is compressed, and the piston does not obstruct a flow path from the first portion of the supply line to the second portion of the supply line.

14. The antifreeze-extinguishing medium interface according to claim 13, wherein the biasing member is a spring.

15. The antifreeze-extinguishing medium interface according to claim 13, wherein the extinguishing medium and antifreeze are separated by the piston.

16. The antifreeze-extinguishing medium interface according to claim 15, wherein the piston slides within the conduit to accommodate thermal expansion of either the extinguishing medium or the antifreeze.

17. The antifreeze-extinguishing medium interface according to claim 13, wherein when the fire suppression system is active, a pressure of the extinguishing medium being pumped into the supply line by the driving source causes the piston to slide from the first position to the second position.

18. The antifreeze-extinguishing medium interface according to claim 13, wherein the biasing member moves the piston out of the second position.

19. The antifreeze-extinguishing medium interface according to claim 13, wherein the distance between the second end and the connection to the second portion of the supply line is about equal to a length of the piston.

20. A method for maintaining a standby pressure in a fire suppression system having a driving source coupled to at least one spray head by a supply line for delivering extinguishing medium thereto, comprising:
generating the standby pressure in the fire suppression system;
opening a thermal expansion assembly coupled to the supply line when the standby pressure exceeds a threshold and the driving source is inoperable to release extinguishing medium and pressure therefrom; and
closing the thermal expansion assembly once the standby pressure is less than or equal to the threshold.

21. The method according to claim 20, wherein the threshold is a pressure of about 45 bar.

22. The method according to claim 20, wherein the extinguishing medium is released into an extinguishing medium tank for reuse in the system.

23. The method according to claim 20, wherein the extinguishing medium is released externally from the system.

24. The method according to claim 20, wherein the thermal expansion assembly is opened hydraulically.

25. The method according to claim 20, wherein the thermal expansion assembly is opened electrically.

26. A method of maintaining a standby pressure in a fire suppression system containing both antifreeze and extinguishing medium within a predetermined threshold comprising:
expanding either the antifreeze or extinguishing medium in the system as a result of a temperature change;
moving a portion of an antifreeze-extinguishing medium interface to accommodate the expansion of either the antifreeze or extinguishing medium; and
opening a thermal expansion assembly to release extinguishing medium from the system.

27. The method according to claim 26, wherein the antifreeze-extinguishing medium interface includes a piston slidable within a conduit.

28. The method according to claim 27, wherein the piston separates the antifreeze and the extinguishing medium.
